(19) United States
(12) Patent Application Publication
(10) Pub. No.: US 2008/0102908 A1
(43) Pub. Date: May 1, 2008

(54) Sliding Mechanism and Portable Communication Device Utilized the Sliding Mechanism

(75) Inventors: Yi-An Chen, Taipei (TW); Shih-Feng Lu, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 11/849,647

(22) Filed: Sep. 4, 2007

(30) Foreign Application Priority Data
Oct. 30, 2006 (TW) 95140084

(51) Int. Cl. H04M 1/00

(52) U.S. Cl. 455/575.4

(57) ABSTRACT

A sliding mechanism for connecting a display housing and an input housing of a portable communication device. The sliding mechanism includes a slide and a sliding element. The slide is fixed on the input housing and the sliding element is fixed on the display housing. The sliding element is slidably provided on the slide so that the display housing can slide relative to the input housing. Both the slide and the sliding element are hidden between the input housing and the display housing when the input housing and the display housing slide relative to each other. A portable communication device utilizing the slide mechanism is also disclosed.

### RELATED APPLICATIONS

This application claims priority to Taiwan Application Serial Number 95140084, filed Oct. 30, 2006, which is herein incorporated by reference.

### BACKGROUND OF THE INVENTION

1. Field of the Invention

The invention relates to a sliding mechanism and, more particularly, to a sliding mechanism of a portable communication device.

2. Description of the Related Art

The cell phone is the wireless phone equipment which can be installed in a communication tool such as a vehicle, a ship, and so on, or can be carried and be freely mobile. The cell phone system, which is different from a cordless phone or a long distance walkie talkie, can make a user obtain and enjoy the same function of a fixed phone installed in the home from the cell phone. Moreover, the cell phone system can supply more convenient use. Thus with a cooperative use of an International Direct Dialing (IDD), the user of the cell phone can directly touch with any user everywhere within the effective range of the system.

In the structure of the cell phone, besides a conventional leather sheath, a lifting cover or a sliding cover is also developed to protect its keyboard panel or screen. Therefore, due to the protection of the above-mentioned lifting cover or the sliding cover, dialing by mistake and damage due to external impact force can be avoided.

However, as for a conventional sliding cover design, a slide is provided on a display housing. When the sliding cover is slid away in a use state, the slide and a torsion spring may be easily exposed to deteriorate esthetics. Further, the torsion spring exposed outside of the housing may be easily directly touched dirtying the slide and the torsion spring, and therefore the sliding cover may not slide smoothly. If the torsion spring and the slide need to be completely hidden in the housing, the slide has to be disposed in the center position of the whole length of the display housing. Therefore the slide is difficult to bypass the keyboard portion of the cell phone, and then a certain thickness of the display housing may be added, which may deteriorate the lightness and the thinness of the cell phone.

Therefore, there exists a need to design a sliding-cover cell phone to make the slide not exposed outside of the housing in the use state.

### BRIEF SUMMARY OF THE INVENTION

The objective of the invention is to provide a sliding mechanism used in a portable communication device, making a slide not exposed to the outside of a housing in a use state.

According to the above objective of the invention, a sliding mechanism is provided for connecting an input housing and a display housing of a portable communication device. The sliding mechanism includes a slide fixed on the input housing and a sliding element fixed on the display housing. The sliding element is slidably provided on the slide so that the display housing can slide relative to the input housing. The length of the sliding element in its sliding direction is less than that of the slide. When the display housing slides, the display housing completely shields the slide and the input housing completely shields the sliding element. That is, both the slide and the sliding element are hidden between the input housing and the display housing.

According to another aspect of the invention, a portable communication device includes a display housing, an input housing, and a sliding mechanism for connecting the display housing and the input housing. The sliding mechanism includes a slide and a sliding element. The slide is fixed on the input housing, and the sliding element is fixed on the display housing. The sliding element is slidably provided on the slide so that the display housing can slide relative to the input housing. The length of the sliding element in its sliding direction is less than that of the slide. When the display housing slides, the display housing completely shields the slide and the input housing completely shields the sliding element.

In the sliding mechanism according to the invention, the slide can be provided in a recessed portion of the input housing to effectively save space and further to reduce the thickness of the portable communication device. When the display housing is slid away, the sliding travel in the slide of the sliding element is hidden between the display housing and the input housing. Therefore, when the portable communication device is used, the slide and a torsion spring may not be exposed. Thus esthetics is ensured, and dirtiness and damage of the slide and the torsion spring are avoided to extend the life of the sliding mechanism since the slide and the torsion spring are not directly touched.

### BRIEF DESCRIPTION OF THE SEVERAL VIEWS OF THE DRAWINGS

These and other features, aspects, and advantages of the present invention will become better understood with regard to the accompanying drawings.

FIG. 1 is an exploded diagram showing a sliding mechanism according to a preferred embodiment of the invention.

FIG. 2A is a non-use state diagram of a portable communication device according to an embodiment of the invention.

FIG. 2B is a use state diagram of a portable communication device according to an embodiment of the invention.

### DETAILED DESCRIPTION OF THE EMBODIMENTS

The spirit of the invention will be described in considerable detail with the drawings and the description, and persons having ordinary skill in the art may make various modifications and changes without departing from the scope and spirit of the invention.

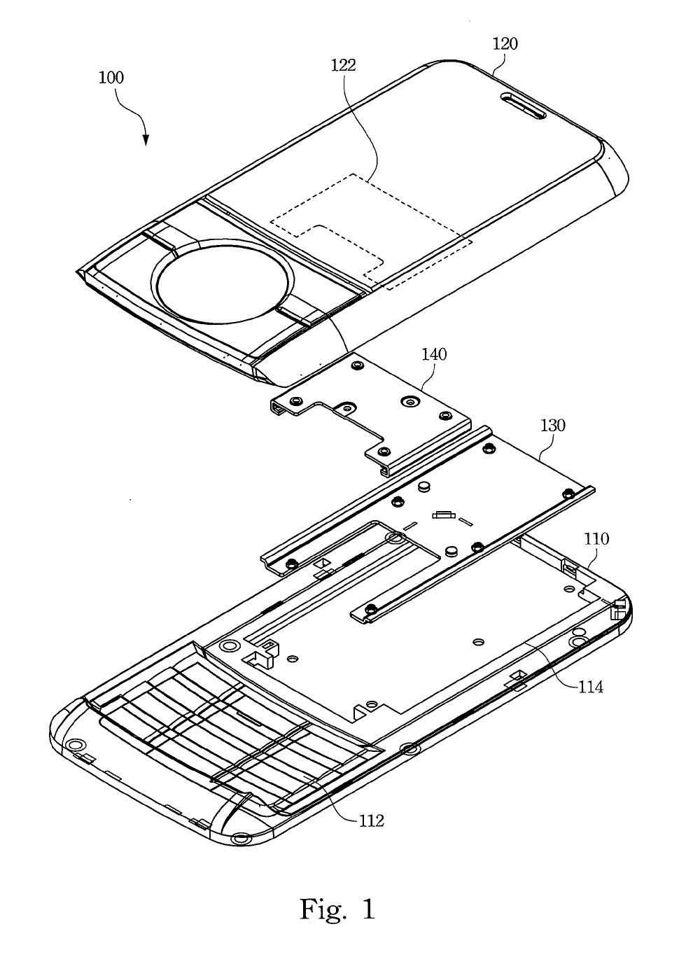

FIG. 1 is an exploded diagram showing a sliding mechanism according to a preferred embodiment of the invention. The sliding mechanism is used in a portable communication device 100 to connect an input housing 110 and a display housing 120 of the portable communication device 100. The sliding mechanism includes a slide 130 and a sliding element 140. The slide 130 is fixed on the input housing 110, and the sliding element 140 is fixed on the display housing 120 and slidably provided on the slide 130 so that the display housing 120 can slide relative to the input housing 110. The length of the sliding element 140 in its sliding direction is less than that of the slide 130. When the display housing 120 slides, the display housing 120 completely shields the slide 130 and the input housing 110 completely shields the sliding element 140.

In this embodiment, the sliding travel in the slide 130 of the sliding element 140 is hidden between the input housing 110 and the display housing 120. Thus in the use state, the slide 130 can be effectively protected since it may not be exposed.

In this embodiment, the input housing 110 has an input portion 112. The slide 130 is disposed on the same side of the input housing 110 with the input portion 112 and preferably, is disposed next to the input portion 112. The sliding element 140 corresponding to the slide 130 is preferably disposed in a center position 122 of the display housing 120. Since the sliding element 140 occupies very small space of the display housing 120, the sliding element 140 may not overlap the input portion 112 of the input housing 110. The input housing 110 may include a recessed portion 114 which is disposed on the same side of the input housing 110 with the input portion 112, and the slide 130 may be fixed in the recessed portion 114. The recessed portion 114 is not in the function region of the portable communication device 100, and therefore the space is effectively saved without the need to add the extra thickness of the portable communication device 100.

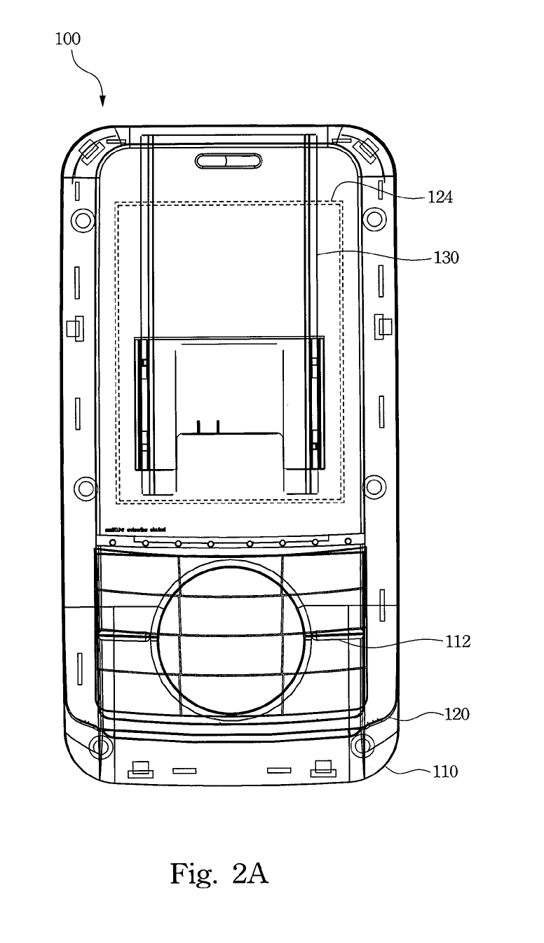

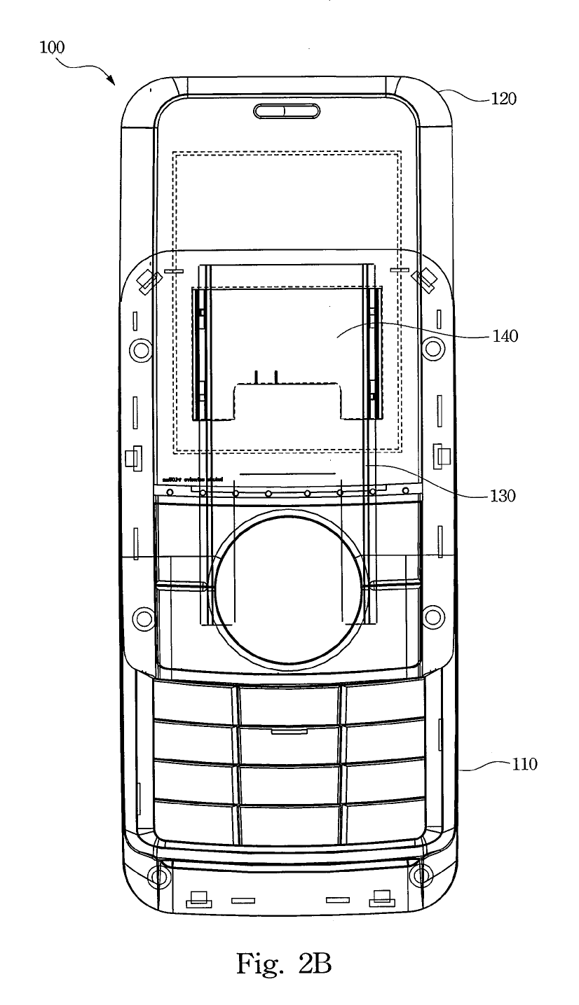

FIG. 2A and FIG. 2B are different state diagrams of a portable communication device according to a preferred embodiment of the invention, respectively. FIG. 2A is a non-use state diagram of the portable communication device 100, wherein the portable communication device 100 uses a sliding mechanism to connect the input housing 110 and the display housing 120. The sliding mechanism includes the slide 130 and the sliding element 140. The slide 130 is fixed on the input housing 110, and the sliding element 140 is fixed on the display housing 120 and slidably provided on the slide 130 so that the display housing 120 can slide relative to the input housing 110. The length of the sliding element 140 in its sliding direction is less than that of the slide 130.

In the prior art, an extra thickness for disposing the slide 130 on the display housing 120 is added to bypass a display screen 124 of the displaying housing 120. Compared with the prior art, in this embodiment, the slide 130 is fixed in the recessed portion 114 of the input housing 110 (as shown in FIG. 1) to effectively save space and further to reduce the thickness of the portable communication device 100.

FIG. 2B is a use state diagram of the portable communication device 100. When the display housing 120 is slid away, the sliding travel in the slide 130 of the sliding element 140 is hidden between the display housing 120 and the input housing 110. Therefore, when the portable communication device 100 is used, the slide 130 may not be exposed. Thus esthetics is ensured, and dirtiness and damage of the slide 130 are avoided to extend the life of the sliding mechanism since the slide 130 is not directly touched.

The material of the display housing 120 and the input housing 110 may be plastic or metal such as stainless steel or alloy of aluminum and magnesium. The material of the slide 130 and the sliding element 140 may be plastic or alloy of magnesium and aluminum. The sliding mechanism may further include a torsion spring provided between the slide 130 and the sliding element 140 to provide a torsional force when the display housing 120 and the input housing 110 are positioned.

Known from the above preferred embodiment of the invention, the advantages of the invention are as follows. In a sliding mechanism according to the invention, a slide can be provided in a recessed portion up an input portion in an input housing. Since the recessed portion is not in a function region, space can be effectively saved and further the thickness of a portable communication device can be reduced. When a display housing is slid away, the sliding travel in the slide of a sliding element is hidden between the display housing and the input housing. Therefore, when the portable communication device is used, the slide and a torsion spring may not be directly exposed. Thus esthetics is ensured, and dirtiness and damage of the slide and the torsion spring are avoided to extend the life of the sliding mechanism since the slide and the torsion spring are not directly touched.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A sliding mechanism for connecting an input housing and a display housing of a portable communication device, the sliding mechanism comprising:
a slide fixed on the input housing; and
a sliding element fixed on the display housing and slidably provided on the slide,
wherein the length of the sliding element in its sliding direction is less than that of the slide, when the display housing and the input housing slide relative to each other, both the slide and the sliding element are hidden between the input housing and the display housing.

2. The sliding mechanism according to claim 1, wherein the sliding mechanism comprises a torsion spring provided between the slide and the sliding element to provide a torsional force when the display housing and the input housing are positioned, and the display housing completely shields the torsion spring.

3. The sliding mechanism according to claim 1, wherein the input housing has an input portion, and the slide and the input portion are disposed on the same side of the input housing.

4. The sliding mechanism according to claim 3, wherein the input housing comprises a recessed portion, the recessed portion and the input portion are disposed on the same side of the input housing, and the slide is fixed in the recessed portion.

5. A portable communication device comprising:
a display housing;
an input housing; and
a sliding mechanism for connecting the display housing and the input housing, wherein the sliding mechanism comprises:
a slide fixed on the input housing; and
a sliding element fixed on the display housing and slidably provided on the slide,
wherein the length of the sliding element in its sliding direction is less than that of the slide, when the display housing and the input housing slide relative to each other, both the slide and the sliding element are hidden between the input housing and the display housing.

6. The portable communication device according to claim 5, wherein the sliding mechanism comprises a torsion spring provided between the slide and the sliding element to provide a torsional force when the display housing and the input housing are positioned, and the display housing completely shields the torsion spring.

7. The portable communication device according to claim 5, wherein the input housing has an input portion, and the slide and the input portion are disposed on the same side of the input housing.

8. The portable communication device according to claim 7, wherein the input housing comprises a recessed portion, the recessed portion and the input portion are disposed on the same side of the input housing, and the slide is fixed in the recessed portion.
